(19) United States
(12) Patent Application Publication
(10) Pub. No.: US 2013/0346298 A1
(43) Pub. Date: Dec. 26, 2013

(54) OFFLINE-SALES ATTRIBUTION SYSTEMS AND METHODS

(71) Applicant: BIZIBLE, INC., Seattle, WA (US)

(72) Inventors: Aaron Bird, Seattle, WA (US); Peter Thompson, Seattle, WA (US); ZengZhong Li, Redmond, WA (US)

(21) Appl. No.: 13/926,901

(22) Filed: Jun. 25, 2013

Related U.S. Application Data
(60) Provisional application No. 61/664,034, filed on Jun. 25, 2012.

(51) Int. Cl. G06Q 20/38

(52) U.S. Cl. CPC G06Q 20/38
USPC 705/39

(57) ABSTRACT

An offline transaction may be attributed to an online activity by receiving a request from a consumer device for a resource that comprises a vendor page. An online-referral source (by which the consumer device identified the vendor page) is determined, and a unique identifier, the online-referral source, and the vendor page are stored in a persistent record. A device-identifier association is created to associate the unique identifier with the consumer device. Subsequently, offline-transaction data is obtained, associating an online-communication address with an offline transaction involving the vendor and an individual or. When a second resource request is received from the consumer device, it is determined to be associated with the unique identifier, and further, that it is associated with the online-communication address and the offline transaction. The vendor is notified that the offline transaction is associated with the online-referral source.

### CROSS-REFERENCE TO RELATED APPLICATIONS

This application claims the benefit of priority to U.S. Provisional Patent Application No. 61/664,034; filed Jun. 25, 2012 under Attorney Docket No. GIVI139687; titled TRACKING REVENUE TO MARKETING SOURCE FOR OFFLINE SALES; and naming inventors Aaron Bird et al. The above-cited application is hereby incorporated by reference, in its entirety, for all purposes.

### FIELD

This disclosure is directed to software, and more particularly, to associating online user activities with offline sales or other transactions.

### BACKGROUND

Businesses may wish to understand how they acquire customers. Businesses invest heavily in multiple marketing efforts. Being able to measure where their customers are coming from allows businesses to invest their marketing dollars where they will have the most impact.

In traditional (offline) advertising models, businesses use a variety of techniques to measure the effectiveness of their marketing, including using separate telephone numbers, separate coupon/discount codes for different marketing campaigns.

However, in an online business model (e.g., an e-store), various techniques are used to track the behavior of users and measure the effectiveness of marketing. For example, online businesses frequently use on-site analytics to track where users came from, how users behave on the business's website, what electronic purchases the users make, and the like.

For example, in a typical online purchase, a user would go to a search engine and type a search query (e.g., “scented candles”) to locate a candle-vendor's website. When the user visits the candle-vendor's website, the candle-vendor's website site can record the fact that the user came from the particular search engine, via a particular query (e.g., “scented candles”). Some portion of the users that visit from that particular search engine with that query will end up making a purchase. And at this point, a value that can be associated with that specific query (e.g., one in ten users end up purchasing an average of $100, from which each click may be determined to be worth $10 on average).

However, there are many cases where a purchase or other transaction is not completed online. For example, if one is looking for a house painter, the completion of the sale is likely offline. Because of the offline nature of the interaction between the business and the consumer, tracking revenue back to the marketing source is problematic using existing analytics.

### BRIEF DESCRIPTION OF THE DRAWINGS

FIG. 1 illustrates a simplified marketing analytics system in which marketing-analytics server, consumer device, vendor device, and referral source are connected to network.

FIG. 2 illustrates several components of an exemplary marketing-analytics server in accordance with one embodiment.

FIG. 3 illustrates an exemplary series of communications between vendor device, consumer device, marketing-analytics server, and referral source in accordance with one embodiment.

FIG. 4 illustrates a routine for associating an identifier with a remote device, such as may be performed by a marketing-analytics server in accordance with one embodiment.

FIG. 5 illustrates a subroutine for associating a given unique identifier with a given remote consumer device in connection with a given page provided by a vendor, such as may be performed by a marketing-analytics server in accordance with one embodiment.

FIG. 6 illustrates a routine for processing offline-transaction data in association with an online-communication address, such as may be performed by a marketing-analytics server in accordance with one embodiment.

FIG. 7 illustrates a routine for generating a tracking-resource identifier associated with a given online-communication address, such as may be performed by a marketing-analytics server in accordance with one embodiment.

FIG. 8 illustrates a routine for processing a “beacon”-resource-file request, such as may be performed by a marketing-analytics server in accordance with one embodiment.

FIG. 9 illustrates a routine for processing a tracking-resource request, such as may be performed by a marketing-analytics server in accordance with one embodiment.

FIG. 10 illustrates a subroutine for determining a consumer-device identifier previously associated with a given consumer device that has made a given resource request, such as may be performed by a marketing-analytics server in accordance with one embodiment.

### DESCRIPTION

In various embodiments, as discussed below, various systems and methods may be employed to make an association between a consumer's online activity, such as performing an online search with a certain search term and search provider, and a subsequent offline transaction involving the consumer and a vendor, such as the consumer making a purchase at a bricks-and-mortar vendor location, the consumer entering into an agreement by phone for the vendor to provide services to the consumer, and the like. Such associations may be reported to the vendor to monitor the efficacy of its online marketing programs, or for other purposes.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

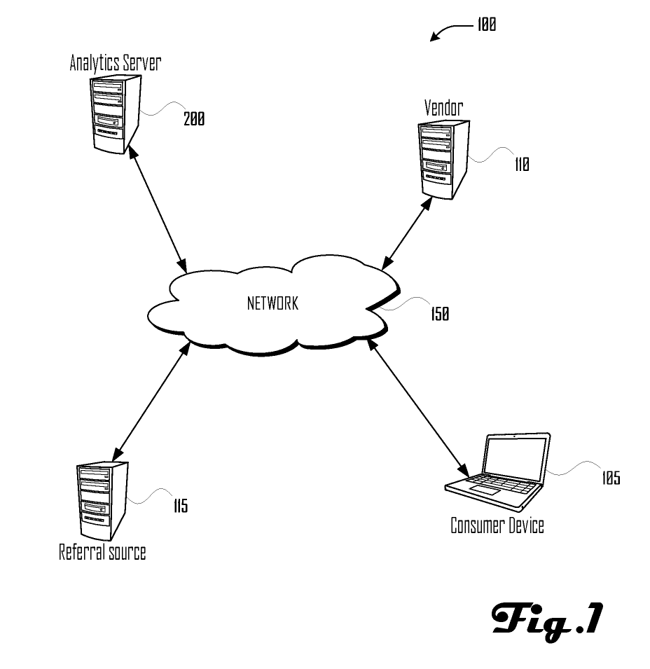

FIG. 1 illustrates a simplified marketing analytics system in which marketing-analytics server 200, consumer device 105, vendor device 110, and referral source 115 are connected to network 150.

In various embodiments, network 150 may include the Internet, a local area network (“LAN”), a wide area network (“WAN”), and/or other data network. In various embodiments, referral source 115 may include an online-search provider or other online entity that may provide a search-results page, marketing page, information page, advertisement, or other online resource that may serve to make a consumer aware of or otherwise direct a consumer to a vendor-provided page or other information resource associated with a product or service that has or will be provided by, brokered by, managed by, or that otherwise involves the vendor.

In various embodiments, additional infrastructure (e.g., cell sites, routers, gateways, firewalls, and the like), as well as additional devices (e.g., devices operated by airlines) may be present. Further, in some embodiments, the functions described as being provided by some or all of marketing-analytics server 200, vendor device 110, and/or referral source 115 may be implemented via various combinations of physical and/or logical devices. However, it is not necessary to show such infrastructure and implementation details in FIG. 1 in order to describe an illustrative embodiment.

In various embodiments, marketing-analytics server 200 may comprise one or more physical and/or logical devices that collectively provide the functionalities described herein. In some embodiments, marketing-analytics server 200 may comprise one or more replicated and/or distributed physical or logical devices.

In some embodiments, marketing-analytics server 200 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

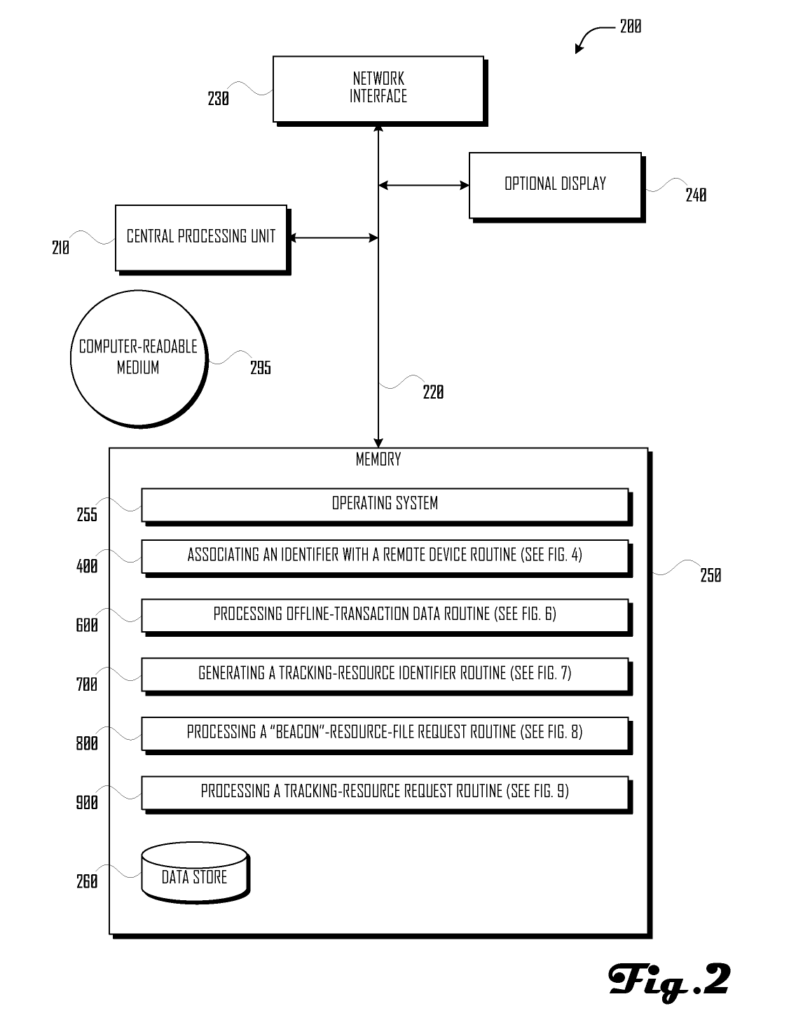

FIG. 2 illustrates several components of an exemplary marketing-analytics server in accordance with one embodiment. In some embodiments, marketing-analytics server 200 may include many more components than those shown in FIG. 2. However, it is not necessary that all of these generally conventional components be shown in order to disclose an illustrative embodiment.

Marketing-analytics server 200 includes a bus 220 interconnecting components including a processing unit 210; a memory 250; optional display 240; and network interface 230.

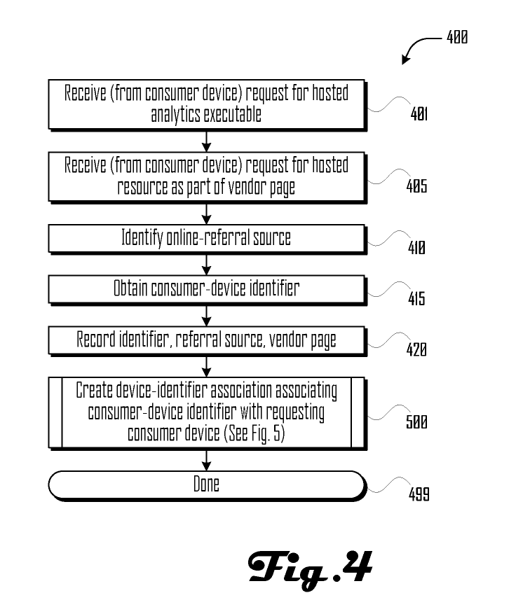

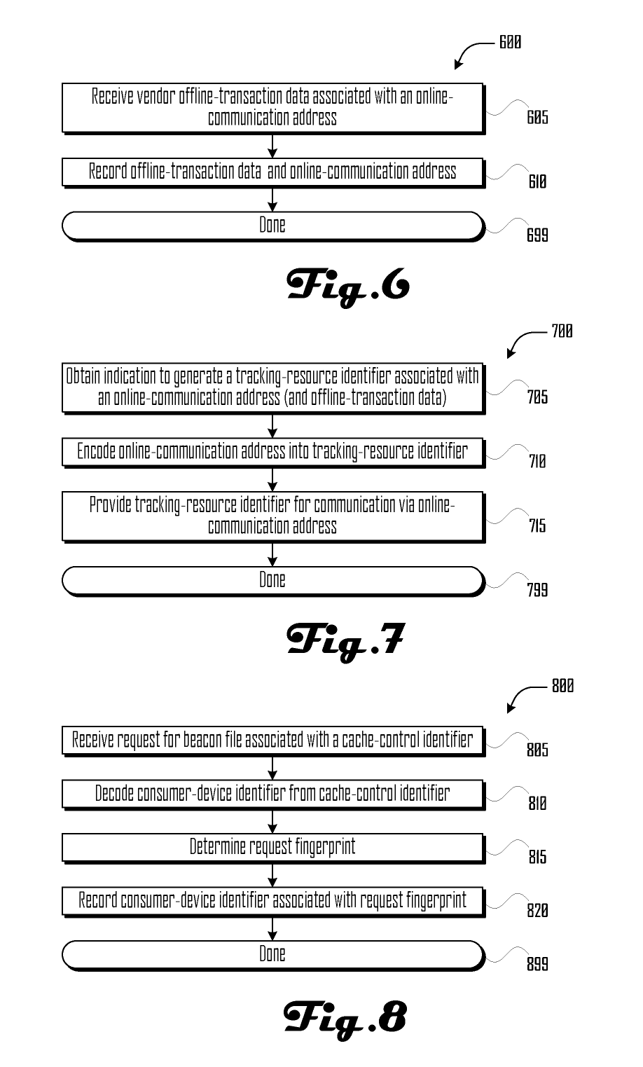

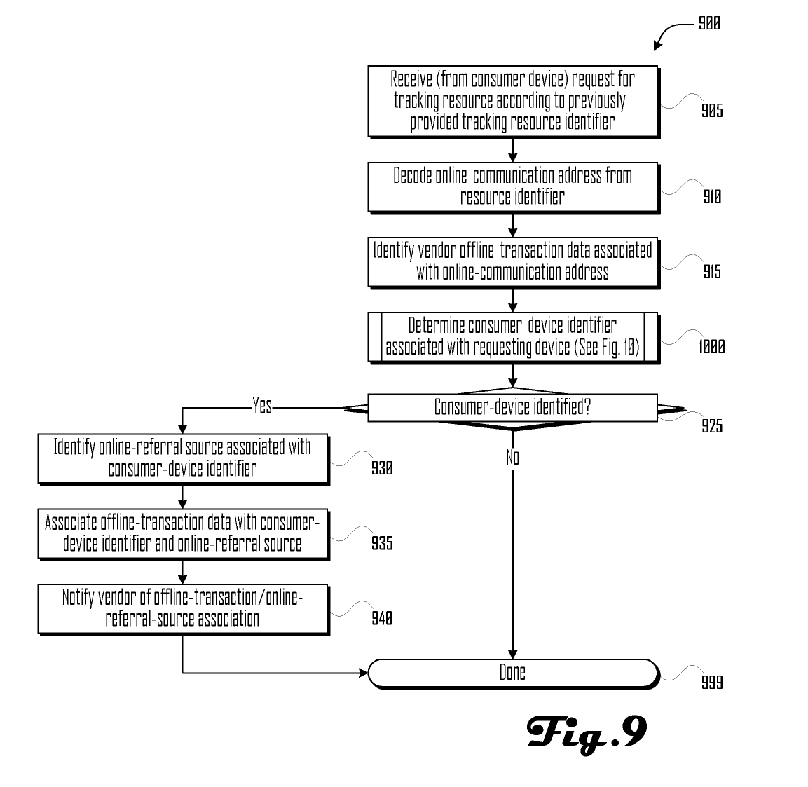

Memory 250 generally comprises a random access memory (“RAM”), a read only memory (“ROM”), and a permanent mass storage device, such as a disk drive. The memory 250 stores program code for a routine 400 for associating an identifier with a remote device (see FIG. 4, discussed below); a routine 600 for processing offline-transaction data in association with an online-communication address (see FIG. 6, discussed below); a routine 700 for generating a tracking-resource identifier associated with a given online-communication address (see FIG. 7, discussed below); a routine 800 for processing a “beacon”-resource-file request (see FIG. 8, discussed below); and a routine 900 for processing a tracking-resource request (see FIG. 9, discussed below). In addition, the memory 250 also stores an operating system 255.

These and other software components may be loaded into memory 250 of marketing-analytics server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

Memory 250 also includes data store 260. In some embodiments, marketing-analytics server 200 may communicate with data store 260 via network interface 230, a storage area network (“SAN”), a high-speed serial bus, and/or via the other suitable communication technology.

In some embodiments, data store 260 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

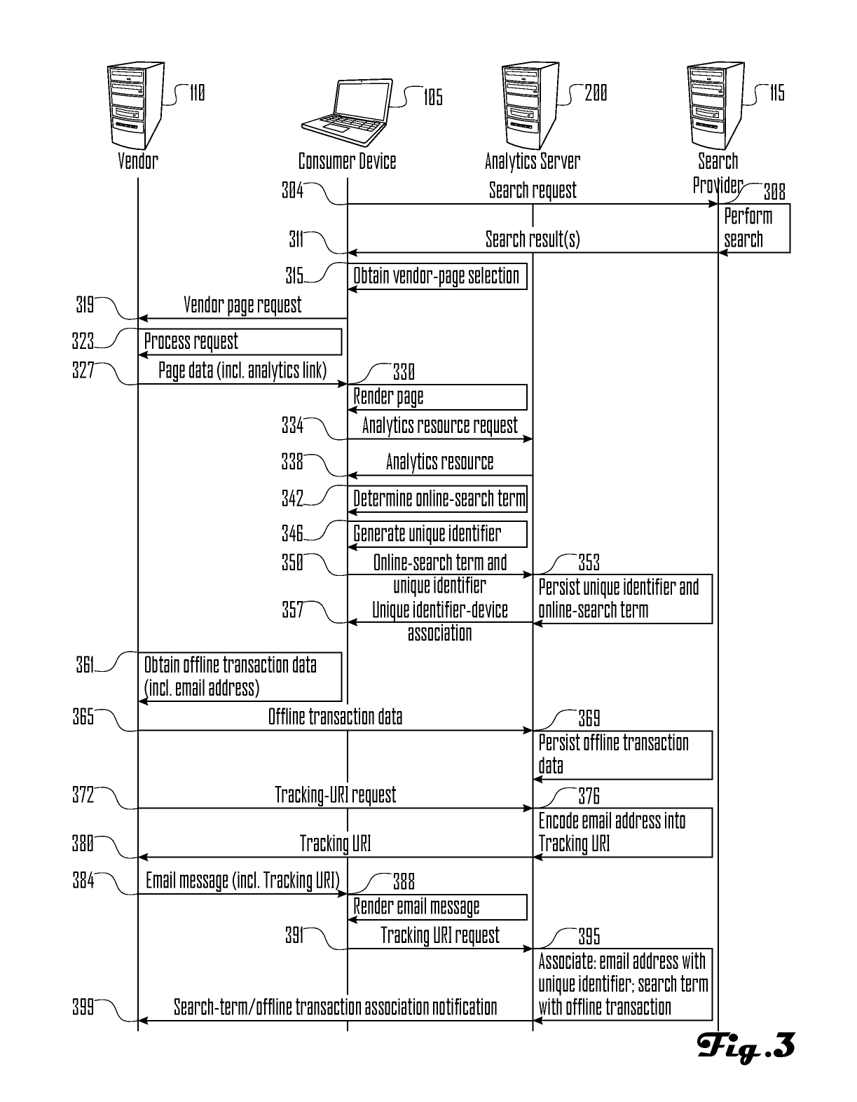

FIG. 3 illustrates an exemplary series of communications between vendor device 110, consumer device 105, marketing-analytics server 200, and referral source 115 in accordance with one embodiment. The communications shown in FIG. 3 do not encompass every combination of possibilities in which the systems and methods provided herein may be employed. Rather, the illustrated communications merely provide an overview of one simplified example scenario. Additional variations and alternatives are described more fully in the Figures and description that follow.

Beginning the illustrated sequence of communications, consumer device 105 sends to referral source 115 a request 304 to provide search results based at least in part on an indicated search term. For example, in one embodiment, a consumer operating consumer device 105 may send a request to search for a term such as “plasma tv”.

Referral source 115 (here, an online-search provider) performs 308 the requested search to obtain a set of one or more search results, one of which refers to a vendor page provided by vendor device 110.

Referral source 115 sends to consumer device 105 the search results 311 (including a link to the vendor page).

After providing the search results to the consumer, consumer device 105 obtains from the consumer (e.g., via an input device associated with consumer device 105) a selection 315 selecting the vendor page from among the search results.

In response, consumer device 105 sends to vendor device 110 a request 319 for data associated with the vendor page. In many embodiment, request 319 may conform to the Hypertext Transfer Protocol (“HTTP”) application protocol, according to which request 319 may include several HTTP header fields. The HTTP “referer” header field includes an identifier (e.g., a Uniform resource identifier or “URI”) identifying the page that linked to the resource being requested (here, the analytics resource).

A Uniform Resource Identifier (“URI”), as the term is used herein, is a string of characters used to identify a resource on a computing device and/or a network, such as the Internet. Such identification enables interaction with representations of the resource using specific protocols. “Schemes” specifying a syntax and associated protocols define each URI.

The generic syntax for URI schemes is defined in Request for Comments (“RFC”) memorandum 3986 published by the Internet Engineering Task Force (“IETF”). According to RFC 3986, a URI (including a URL) consists of four parts:
<scheme name>: <hierarchical part>[?<query>] [#<fragment>]

A URI begins with a scheme name that refers to a specification for assigning identifiers within that scheme. The scheme name consists of a letter followed by any combination of letters, digits, and the plus (“+”), period (“.”), or hyphen (“-”) characters; and is terminated by a colon (“:”).

The hierarchical portion of the URL is intended to hold identification information that is hierarchical in nature. Often this part is delineated with a double forward slash (“//”), followed by an optional authority part and an optional path.

The optional authority part holds an optional user information part (not shown) terminated with “@” (e.g. username:password@), a hostname (i.e., domain name or IP address, here “example.com”), and an optional port number preceded by a colon “:”.

The path part is a sequence of one or more segments (conceptually similar to directories, though not necessarily representing them) separated by a forward slash (“/”). If a URI includes an authority part, then the path part may be empty.

The optional query portion is delineated with a question mark and contains additional identification information that is not necessarily hierarchical in nature. Together, the path part and the query portion identify a resource within the scope of the URI's scheme and authority. The query string syntax is not generically defined, but is commonly organized as a sequence of zero or more <key>=<value> pairs separated by a semicolon or ampersand, for example:
key1=value1; key2=value2; key3=value3 (Semicolon), or
key1=value1&key2=value2&key3=value3 (Ampersand)

Much of the above information is taken from RFC 3986, which provides additional information related to the syntax and structure of URIs. RFC 3986 is hereby incorporated by reference, for all purposes.

Vendor device 110 processes 323 the request to obtain page data (e.g., one or more HTML files), which includes a link to an analytics resource provided by marketing-analytics server 200. For example, in one embodiment, the analytics resource may comprise a JavaScript or other executable file, an image file, or other resource. In one embodiment, an executable analytics resource may, when executed on a client, cause the client to request an image file or other resource hosted by marketing-analytics server 200.

Vendor device 110 sends to consumer device 105 the page data 327 (including the link to the analytics resource).

Consumer device 105 uses the page data thereby received to render 330 the vendor page to the consumer.

In the course of rendering the vendor page consumer device 105 may identify the link to the analytics resource discussed above. Consequently, consumer device 105 sends to marketing-analytics server 200 at least one request 334 for the analytics resource.

Marketing-analytics server 200 sends to consumer device 105 the requested analytics resource (e.g., a JavaScript or other executable file).

Consumer device 105 executes the analytics resource, which by checking the referer header field (or by accessing similar metadata associated with the request), can identify the search-results page from which the request for the vendor page originated. In many cases, the URI identifying the search-results page may include a parameter from which the executing analytics resource can determine 342 the online-search term (or other online-referral source) that the consumer entered to find the vendor page.

For example, in one embodiment, the request for the vendor page may include a header such as the following.
Referer: http://www.google.com/search?hl=en&q=plasma+tv . . .

By parsing the referer URI, the executing analytics resource may determine that the consumer found the vendor page by searching for the term “plasma tv”.

Still executing the analytics resource, consumer device 105 generates 346 a unique identifier that will be associated with consumer device 105 as discussed below. For example, in one embodiment, the unique identifier may comprise a universally unique identifier (“UUID”) 128-bit number. In other embodiments, marketing-analytics server 200 may generate the unique identifier (not shown).

Consumer device 105 sends to marketing-analytics server 200 the online-referral source and unique identifier, as determined and generated above. In some embodiments, the executing analytics resource may encode such data into a query portion of a URI and send to marketing-analytics server 200 a request for a resource identified by the URI (e.g., an image file).

Marketing-analytics server 200 persists 353 (e.g., in data store 260) the unique identifier and the online-referral source for subsequent use as described below. In other embodiments, marketing-analytics server 200 may instruct consumer device 105 to store some or all such data in local storage that may be subsequently accessible by marketing-analytics server 200.

Via communication with consumer device 105, marketing-analytics server 200 creates an association 357 between consumer device 105 and unique identifier that is likely to allow marketing-analytics server 200 to obtain unique identifier in the event that consumer device 105 sends to marketing-analytics server 200 a future request for some resource hosted by marketing-analytics server 200. See subroutine 500, discussed below, for a more detailed discussion of creating such a device-identifier association.

At some point subsequent to the communications described above, vendor device 110 obtains 361 offline-transaction data associating an online-communication address (e.g., an email address, twitter handle, social-media ID, or other like address) with an offline transaction involving the vendor and an individual or entity.

The term “offline”, when used herein, is used to differentiate the technical means used to perform an “online” search using an online-search term or to otherwise obtain an online-referral source, as discussed above, from a different technical or non-technical means used to initiate, progress, and/or consummate a commercial transaction.

For example, in one embodiment, after performing an online search via a web browser, the consumer may physically visit a bricks-and-mortar showroom operated by the vendor and purchase a plasma television set. In the course of completing that offline transaction, the consumer may provide the vendor with an email or other online-communication address so that the vendor may, for example, email a receipt to the consumer.

At the point of sale, the vendor knows (or can discover) that someone performed an online search, and the vendor knows that it has entered into a transaction with a consumer. However, the vendor does not know that the consumer who performed the online search is the same consumer who made the offline purchase.

For another example, after performing an online search via a web browser, the consumer may pursue and/or enter into an offline transaction with a vendor using non-web-browsing communication technology such as by telephone, paper letter, fax, text message, or the like.

By contrast, if after performing an online search via a web browser, the consumer enters into a non-offline transaction via the web browser, then the vendor may be able to associate the online search with the non-offline transaction using previously-known methods.

Vendor device 110 sends to marketing-analytics server 200 the offline-transaction data 365 thereby obtained.

Marketing-analytics server 200 persists 369 the offline-transaction data (e.g., in data store 260).

At some point contemporaneous with or subsequent to receiving the offline-transaction data discussed above, marketing-analytics server 200 receives from vendor device 110 a request 372 to provide a tracking URI or similar identifier associated with the offline-transaction-associated online-communication address.

For example, in one embodiment, vendor device 110 may be in the process of generating an online communication (e.g. a sales receipt, marketing information, or the like) to be sent to the consumer via the online-communication address.

In response to receiving the tracking-URI request, marketing-analytics server 200 encodes 376 the offline-transaction-associated online-communication address into a tracking URI. For example, in one embodiment, the “path” portion of a URI may refer to an image file hosted by marketing-analytics server 200, while the online-communication address may be encoded into the optional query portion of the URI (as discussed above).

Marketing-analytics server 200 sends to vendor device 110 a tracking URI 380 that has been encoded with the online-communication address.

Vendor device 110 sends to consumer device 105 an online communication 384 that includes the tracking URI.

At some point after receiving the online communication, consumer device 105 renders 388 the online communication to the consumer.

In the course of rendering the online communication, consumer device 105 sends to marketing-analytics server 200 a request 391 for the resource (e.g., an image file) hosted by marketing-analytics server 200 and identified by the tracking URI.

Using the device-identifier association discussed briefly above and more thoroughly below, marketing-analytics server 200 associates 395 the online-communication address encoded in the tracking-URI request with the unique identifier associated with consumer device 105. Marketing-analytics server 200 is therefore able to associate the offline transaction with the online-referral source used by the consumer to find the vendor.

At some point thereafter, marketing-analytics server 200 sends to vendor device 110 a notification 399 that the online-referral source is associated with the offline transaction.

FIG. 4 illustrates a routine 400 for associating an identifier with a remote device, such as may be performed by a marketing-analytics server 200 in accordance with one embodiment.

In block 401, routine 400 receives from a consumer device (e.g. consumer device 105) a request for an executable analytics resource, which is one component of a vendor page. For example, in one embodiment as discussed above, the executable analytics resource may comprise a JavaScript file or other executable file. In some embodiments, the consumer device may be caused to send the request when it renders a vendor page.

In some embodiments, the executable analytics resource may execute on the consumer device, determine certain metadata (as discussed below) and cause the consumer device to send a request for an analytics resource, request is received by routine 400 in block 405.

In block 410, routine 400 identifies an online-referral source (possibly including, e.g., an online-search term) by which the requesting consumer identified the vendor page of which the analytics resource is a component.

As discussed above, an executable analytics resource may determine metadata such as the online-referral source and encode it (e.g., into the query portion) into the URI identifying the analytics resource requested in block 405.

By accessing such metadata associated with the request, routine 400 can identify the search-results page from which the request originated. In many cases, the URI identifying the search-results page may include a parameter from which routine 400 can determine the online-referral source that the consumer entered to find the vendor page.

In block 415, routine 400 obtains a consumer-device identifier that will be used to associate the requesting consumer device with the online-referral source (as determined in block 410). In some embodiments, the consumer-device identifier may be a unique identifier, such as a UUID or the like. In some embodiments, routine 400 may obtain the consumer-device identifier by generating it. In other embodiments, the requesting consumer device may generate the consumer-device identifier (e.g. by executing a JavaScript or other executable file provided by marketing-analytics server 200) and communicate it to routine 400.

In block 420, routine 400 persists the consumer-device identifier (as generated in block 415) and the online-referral source (as determined in block 410), associating each with the vendor page (of which the requested analytics resource is a component). For example, in one embodiment, routine 400 may store one or more records in data store 260. In other embodiments, routine 400 may store one or more documents in a local storage facility provided by the requesting consumer device, such as via an HTML5 “Web Storage” API.

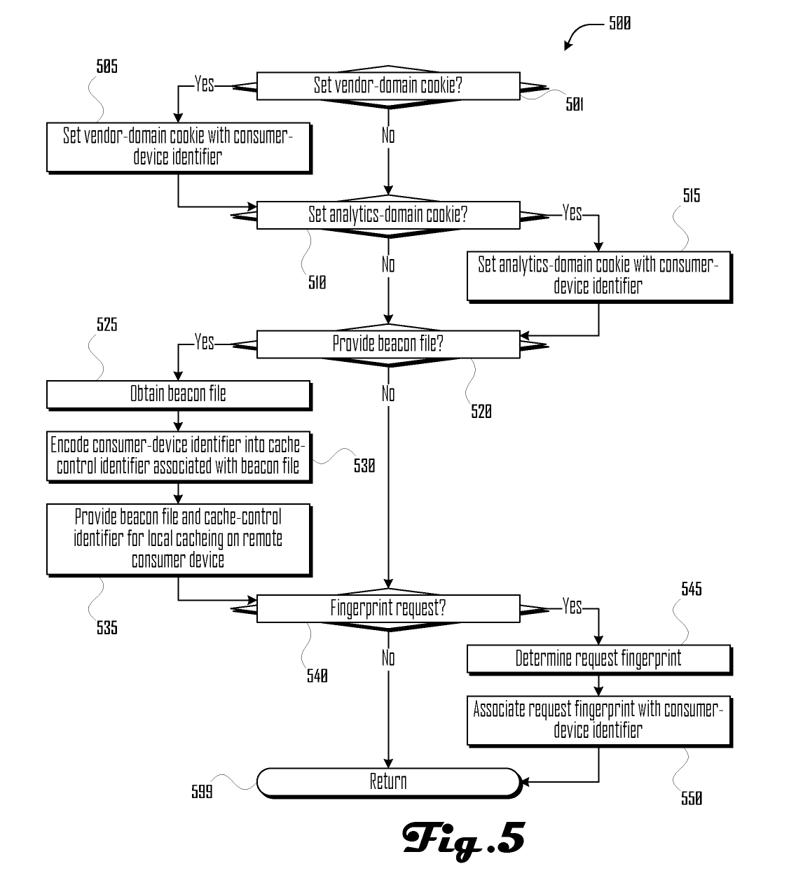

In subroutine block 500, routine 400 calls subroutine 500 (see FIG. 5, discussed below) to create a device-identifier association, such that when the requesting consumer device subsequently requests a resource from the machine performing routine 400, the consumer-device identifier is likely to be readable, which will allow the machine to associate the requesting consumer device with the online-referral source (as determined in block 410).

Routine 400 ends in ending block 499.

FIG. 5 illustrates a subroutine 500 for associating a given unique identifier with a given remote consumer device in connection with a given vendor-page provided by a vendor, such as may be performed by a marketing-analytics server 200 in accordance with one embodiment.

A “cookie”, also known as an HTTP cookie, web cookie, or browser cookie, is a small piece of data sent from a website and stored in a user's web browser while the user is browsing the website. Subsequently, when the user visits a page in the same domain as the website, the data stored in the cookie is sent back to HTTP server by the browser.

So-called “first-party” cookies are cookies that are set and readable from the host domain of a given website, while “third-party” cookies are set and readable from any domain other than the host domain of a given website. In some cases, a web browser may block or otherwise restrict setting and reading first- and/or third-party cookies.

In decision block 501, subroutine 500 determines whether to set a cookie from a domain associated with the vendor that provides the given page (a “vendor-domain cookie”). In various embodiments, depending on which server is performing subroutine 500 and on how that server is configured, such a cookie may be either a first- or third-party cookie.

In various embodiments, subroutine 500 may determine whether to set a vendor-domain cookie based on a predetermined configuration setting and/or on factors such as whether the given remote consumer device will allow subroutine 500 to set such a vendor-domain cookie.

If in decision block 501, subroutine 500 determines to set a vendor-domain cookie, then subroutine 500 proceeds to block 505. Otherwise, subroutine 500 proceeds to decision block 510.

In block 505, subroutine 500 sets a vendor-domain cookie on the given remote consumer device.

To set a cookie, subroutine 500 replies to an HTTP request with a response message including a status line and a “Set-Cookie” response header. For example, in one embodiment, subroutine 500 may set a cookie by sending a response message including data such as the following.
HTTP/1.1 200 OK
Content-type: text/html
Set-Cookie: BizDeviceID=5366eaff-0be7-4a8a-8ad9-74cb2b3060f1

In decision block 510, subroutine 500 determines whether to set a cookie from a domain associated with an analytics provider such as operates marketing-analytics server 200 (a “analytics-domain cookie”). In most cases, such a cookie may be a third-party cookie.

In various embodiments, subroutine 500 may determine whether to set an analytics-domain cookie based on a predetermined configuration setting and/or on factors such as whether the given remote consumer device will allow subroutine 500 to set such an analytics-domain cookie.

If in decision block 510, subroutine 500 determines to set an analytics-domain cookie, then subroutine 500 proceeds to block 515. Otherwise, subroutine 500 proceeds to decision block 520.

In block 515, subroutine 500 sets an analytics-domain cookie on the given remote consumer device.

In some cases, first- and/or third-party cookies may be disabled by the given remote consumer device. In other cases, even if cookies are enabled at the time subroutine 500 is run, the consumer operating the given remote consumer device may delete cookie data before making a subsequent request of the machine performing subroutine 500. To increase the likelihood that the association created by subroutine 500 will be accessible when a subsequent request is made, various embodiments may employ non-cookie-based means to associate the given unique identifier with the given remote consumer device.

For example, in decision block 520, subroutine 500 determines whether to provide a “beacon” resource file. The “beacon” resource file embodiment described below utilizes an HTTP cache-control mechanism to create the desired association. In other embodiments, subroutine 500 may employ similar or different non-cookie-based association techniques.

In various embodiments, subroutine 500 may determine whether to provide a “beacon” resource file based on a predetermined configuration setting and/or on factors such as whether the given remote consumer device will locally cache image files or other resources.

If in decision block 520, subroutine 500 determines to provide a “beacon” resource file, then subroutine 500 proceeds to block 525. Otherwise, subroutine 500 proceeds to decision block 540.

In block 525, subroutine 500 obtains a resource file that will be used as part of a non-cookie-based association scheme. In some embodiments, the resource file may comprise a small image file. In other embodiments, the resource file may comprise any other type of resource that the given remote consumer device will locally cache.

In block 530, subroutine 500 encodes the consumer-device identifier into a cache-control identifier associated with the resource file. For example, in one embodiment, the cache-control identifier may comprise an HTTP entity tag or “ETag”. An ETag may be set using an (optional) “ETag” HTTP response header. So, to encode the consumer-device identifier into a cache-control identifier using the “ETag” response header, subroutine 500 may transform the consumer-device identifier (if necessary) into a string that can be transmitted in an HTTP response header.

In other embodiments, the cache-control identifier may comprise a “Last-Modified” HTTP response header. So, to encode the consumer-device identifier into a cache-control identifier using the “Last-Modified” response header, subroutine 500 may transform the consumer-device identifier into a representation of a data and/or time value that can be transmitted in an HTTP response header. For example, in one embodiment, subroutine 500 may transform the consumer-device identifier into a number that can be interpreted as minutes, seconds, days, or the like since a predetermined epoch.

In block 535, subroutine 500 provides the resource file and associated cache-control identifier to be locally cached on the given remote consumer device. For example, in one embodiment, subroutine 500 may send the resource file to the given remote consumer device accompanied by an HTTP response header including data such as the following.
ETag: “5366eaff-0be7-4a8a-8ad9-74cb2b3060f1”

In other embodiments, subroutine 500 may send the resource file to the given remote consumer device accompanied by an HTTP response header including data such as the following.
Last-Modified: Tue, 15 NOV 1994 12:45:26 GMT

In some embodiments, the consumer may clear a local device cache before making a subsequent request of the machine performing subroutine 500. In other embodiments, it may be disallowed or undesirable to use cache-control mechanisms for purposes such as those described herein. In such embodiment, it may be desirable to create an association that does not rely on the given remote consumer device to store data in a way that can be subsequently read by the machine performing subroutine 500.

To increase the likelihood that the association created by subroutine 500 will be accessible when a subsequent request is made, in decision block 540, subroutine 500 determines whether to determine and store a request “fingerprint”, as described further below.

In various embodiments, subroutine 500 may determine whether to determine and store a request “fingerprint” based on a predetermined configuration setting.

If in decision block 540, subroutine 500 determines to determine and store a request “fingerprint”, then subroutine 500 proceeds to block 545. Otherwise, subroutine 500 proceeds to ending block 599.

In block 545, subroutine 500 determines a request “fingerprint” associated with the given remote consumer device and a request made in the course of rendering the given page.

As discussed above, the HTTP protocol defines many standard HTTP header fields, and many other non-standard request headers are commonly employed. In various embodiments, some or all of the HTTP header field values provided when the given remote consumer device makes a request may be processed along with additional request metadata to create a “fingerprint” of the request.

For example, in one embodiment, an IP address associated with the given remote consumer device may be combined with the value of a “User-Agent” HTTP request header to create a request fingerprint that, while it may not uniquely identify the given remote consumer device, may distinguish requests made by the given remote consumer device from requests made by most other devices.

To combine metadata into a request “fingerprint”, subroutine 500 may employ techniques such as concatenating the metadata values and/or processing the metadata values via a cryptographic hash function.

In block 550, subroutine 500 associates the request “fingerprint” (as determined in block 545) with the given unique identifier. For example, in one embodiment, subroutine 500 may store one or more records (e.g. in data store 260) making the association between the request “fingerprint” and the given unique identifier.

Subroutine 500 ends in ending block 599, returning to the caller.

FIG. 6 illustrates a routine 600 for processing offline-transaction data in association with an online-communication address, such as may be performed by a marketing-analytics server 200 in accordance with one embodiment.

In block 605, routine 600 receives offline-transaction data associating an online-communication address with an offline transaction involving a vendor and an individual or entity. In some embodiments, the vendor may periodically report aggregate data associated with a number of completed, in-progress, or pending offline transactions. In other embodiments, the vendor may report data associated with individual offline transactions as those transactions are initiated, completed, or at some other point during the lifetime of a transaction.

In various embodiments, the vendor may communicate such data to routine 600 via any suitable communication technology, including via an application programming interface provided by marketing-analytics server 200, via integration with a data storage component provided for or operated by the vendor, via physical transport of a storage artifact having the data encoded thereon, or the like.

In one embodiment, data associated with a particular offline transaction may be encoded into the query string of a URI identifying a resource hosted by marketing-analytics server 200.

In various embodiments, an offline transaction may comprise purchasing or entering into an agreement to purchase, rent, or otherwise commercially engage with a product or service that has or will be provided by, brokered by, managed by, or that otherwise involves a vendor.

A transaction is considered to be “offline” when the communications technology used to pursue, enter, and/or consummate the transaction differs from that used to find the vendor via an online search.

In block 610, routine 600 records the offline-transaction data in association with the online-communication address. For example, in one embodiment, routine 600 may create and/or update one or more records in a database (e.g., data store 260).

Routine 600 ends in ending block 699.

FIG. 7 illustrates a routine 700 for generating a tracking-resource identifier associated with a given online-communication address, such as may be performed by a marketing-analytics server 200 in accordance with one embodiment.

In other embodiments, some or all portions of routine 700 may be performed by a vendor using a plugin or other software provided by an analytics provider that operates marketing-analytics server 200.

In block 705, routine 700 obtains an indication to generate a tracking-resource identifier associated with an online-communication address. In some embodiments, the indication may be received from a remote vendor via an application programming interface provided by marketing-analytics server 200. In other embodiments, routine 700 may be executing on a device operated by a vendor (e.g. as a plugin or extension to a communication application), in which the indication may be received from a local input device.

In block 710, routine 700 encodes the given online-communication address into a tracking-resource identifier. For example, in one embodiment, the tracking resource may comprise an image file or other resource hosted by an analytics provider (e.g. marketing-analytics server 200), and the given online-communication address may be encoded into the query string of a URI identifying the image file or other resource.

In block 715, routine 700 provides the tracking-resource identifier for communication via the online-communication address to an individual or entity. For example, in one embodiment, the tracking-resource identifier may be included in HTML data comprising the body of a message sent by the machine performing routine 700 or by another machine operated by or at the direction of a vendor. As discussed above, in some embodiments, that message may comprise a receipt or other communication related to an offline transaction.

In some embodiments, the body of such a message sent via the online-communication address may also contain an identifier identifying a “beacon” resource file, as discussed above in reference to block 535 of FIG. 5, such that when rendering the message, a consumer device may send requests to marketing-analytics server 200 for the tracking resource and the “beacon” resource file.

Routine 700 ends in ending block 799.

FIG. 8 illustrates a routine 800 for processing a “beacon”-resource-file request, such as may be performed by a marketing-analytics server 200 in accordance with one embodiment.

In block 805, routine 800 receives a request for a “beacon” resource file associated with a previously provided cache-control identifier. (See blocks 525, 530, and 535, discussed above in reference to FIG. 5, above.)

For example, in one embodiment, the machine performing routine 800 may have previously provided a resource file and associated cache-control identifier (e.g., an HTTP entity tag) to be locally cached on a given remote consumer device. When the given remote consumer device subsequently requests that same resource file, it may include the cache-control identifier as a request header or similar metadata, such as the following.
If-None-Match: 5366eaff-0be7-4a8a-8ad9-74cb2b3060f1

In other embodiments, the machine performing routine 800 may have previously provided a resource file and associated cache-control identifier (e.g., an HTTP “Last-Modified” header) to be locally cached on a given remote consumer device. When the given remote consumer device subsequently requests that same resource file, it may include the cache-control identifier as a request header or similar metadata, such as the following.
If-modified-Since: Tue, 15 NOV 1994 12:45:26 GMT

In block 810, routine 800 decodes the consumer-device identifier from the cache-control identifier received in block 805. In some embodiments, “decoding” the consumer-device identifier may simply comprise reading a request header (or similar metadata) and/or transforming request-header data (e.g., a data and/or time value) into a consumer-device identifier. In other embodiments, “decoding” the consumer-device identifier may include using the cache-control identifier metadata to locate a record in a database (e.g., data store 260).

As discussed above in reference to block 545 of FIG. 5, one or more HTTP header fields (or similar metadata) may be combined with the value of a “User-Agent” HTTP request header to create a request fingerprint that may distinguish requests made by a given remote consumer device from requests made by most other devices.

Using the same process as that employed by subroutine 500, in block 815, routine 800 determines a request “fingerprint” associated with the request (as received in block 805).

In block 820, routine 800 records the consumer-device identifier decoded in block 810 in association with the request “fingerprint” determined in block 815, e.g. by storing one or more records in a data store such as data store 260. In addition, routine 800 associates the consumer-device identifier and request “fingerprint” with a current date and/or time.

Routine 800 ends in ending block 899.

FIG. 9 illustrates a routine 900 for processing a tracking-resource request, such as may be performed by a marketing-analytics server 200 in accordance with one embodiment.

As discussed above in reference to FIG. 7, an online-communication address may be encoded into a tracking-resource identifier, e.g. in the query string of a URI identifying an image file or other resource. The tracking-resource identifier may be communicated via the online-communication address to an individual or entity, e.g. in HTML data comprising the body of an email or other message. In the course of rendering that message, a consumer device may send a request for the image or other resource identified by the tracking-resource identifier.

In block 905, routine 900 receives, from a consumer device, such a request for a tracking resource according to a previously-provided tracking-resource identifier.

In block 910, routine 900 decodes an online-communication address from the tracking-resource identifier requested in block 905. For example, in one embodiment, routine 900 may parse a query portion of the tracking-resource identifier to identify a key=value pair that corresponds to the online-communication address. In such an embodiment, the tracking-resource identifier may include data similar to the following.
http://bizible.com/resources/image.png?email=joe.smith%40gmail.com

From such a tracking-resource identifier, routine 900 may identify the “email=joe.smith%40gmail.com” key=value pair of the query portion of the URL, and decode therefrom the online-communication address “joe.smith@gmail.com”. Other embodiments may employ other suitable techniques for decoding the online-communication address from the tracking-resource identifier.

In block 915, routine 900 identifies vendor-provided offline-transaction data associated with the online-communication address decoded in block 910. For example, in one embodiment, using the decoded online-communication address, routine 900 may locate a record (e.g. in data store 260) previously stored by routine 600, as shown and described in FIG. 6.

In other embodiments, offline-transaction data may be encoded in the tracking-resource identifier received in block 905, in a manner similar to that by which an online-communication address is encoded in the tracking-resource identifier, as discussed above. For example, in such an embodiment, the tracking-resource identifier may include data such as the following.
http://bizible.com/resources/image.png?email=joe.smith%40gmail.com&sku=26LN4500&price=uSD299&date=2013-06-19T14%3A50%3A52-07%3A00

Again, by parsing the query portion of the tracking-resource identifier to identify one or more predetermined transaction-data keys (e.g., “sku”, “price”, “date”, and the like), one or more pieces of offline-transaction data may be identified. In the example provided above, routine 900 may identify data indicating that an individual associated with the online-communication address “joe.smith@gmail.com” purchased a 26″ television for USD299 on the afternoon of Jun. 19, 2013.

In other embodiments, offline-transaction data may include more, fewer, and/or different fields of information.

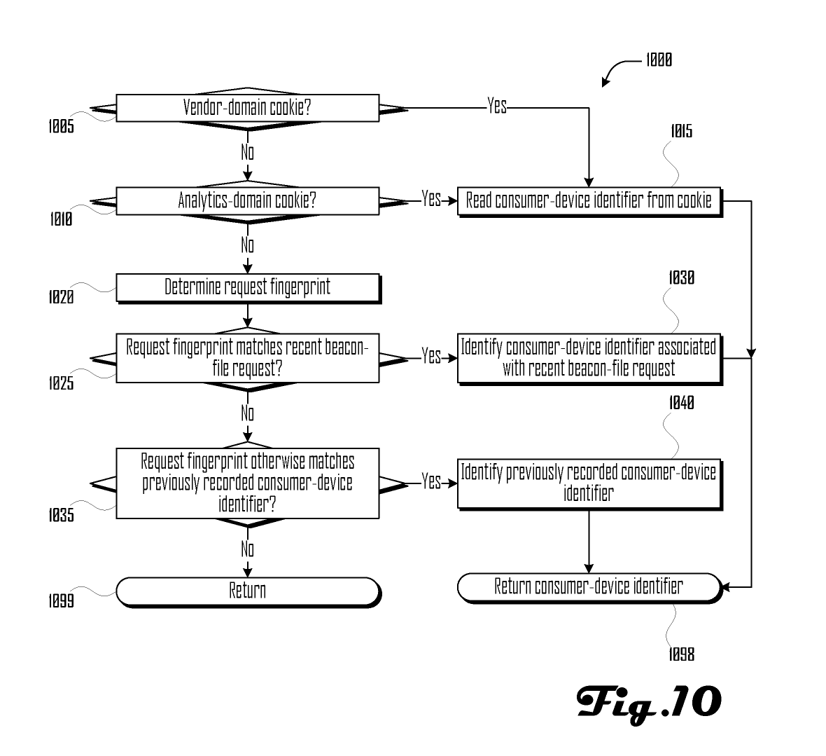

In subroutine block 1000, routine 900 calls subroutine 1000 (see FIG. 10, discussed below) to determine a consumer-device identifier associated with the consumer device that sent the tracking-resource identifier request received in block 905.

As discussed below, in some embodiments, subroutine 1000 may match a consumer-device identifier to the consumer device with varying degrees of confidence. In some cases, subroutine 1000 may make a highly confident match, but in many embodiments even less confident matches may still be useful for marketing purposes.

For example, in one embodiment, if subroutine 1000 must rely on request “fingerprints”, it may be unable to distinguish between several consumer devices that share an IP address and user-agent string (for example). Nevertheless, routine 900 may ultimately be able to determine that, among those several consumer devices, one or more online-referral sources (possibly including, e.g., an online-search term) were used and one or more offline transactions were entered into. Such information may be usefully reported to a vendor, even though routine 900 may not be able to determine that one particular consumer device is associated with one particular online-referral source and offline transaction.

In decision block 925, routine 900 determines whether routine 900 identified a consumer-device identifier in subroutine block 1000. If so, then routine 900 proceeds to block 930. Otherwise, routine 900 proceeds to ending block 999.

In block 930, routine 900 identifies at least one online-referral source associated with the consumer-device identifier identified in subroutine block 1000. For example, in one embodiment, routine 900 may use the consumer-device identifier to locate a record previously stored in a data store (e.g., data store 260), as discussed above in reference to block 420 of FIG. 4.

In block 935, routine 900 associates the offline-transaction data identified in block 915 with the consumer-device identifier identified in subroutine block 1000 and the (at least one) online-referral source identified in block 930. For example, in one embodiment, routine 900 may create or update one or more records (e.g., in data store 260) such that the offline transaction may be attributed, at least in part, to the (at least one) online-referral source.

In block 940, routine 900 notifies the vendor of the association that routine 900 has determined between the (at least one) online-referral source and the offline transaction. In various embodiments, such notification may include a batch process whereby recently-determined associations are periodically reported in aggregate to the vendor. For example, in one embodiment, routine 900 may on one or more occasions, provide a report indicating that a given set of offline transactions are at least partially attributable to one or more online-referral sources.

Routine 900 ends in ending block 999.

FIG. 10 illustrates a subroutine 1000 for determining a consumer-device identifier previously associated with a given consumer device that has made a given resource request, such as may be performed by a marketing-analytics server 200 in accordance with one embodiment.

As discussed above in reference to FIG. 5, subroutine 500 may employ various strategies to increase the likelihood that the association created by subroutine 500 will be accessible by subroutine 1000 when a subsequent request is made. To that end, subroutine 1000 employs a parallel set of strategies to attempt to determine a previously created device-identifier association to varying degrees of certainty.

In decision block 1005, subroutine 1000 determines whether it can access a vendor-domain cookie stored on the requesting consumer device. In various embodiments, depending on how marketing-analytics server 200 is configured, such a cookie may be either a first- or third-party cookie.

In various embodiments, subroutine 1000 may determine whether it can access a vendor-domain cookie based in part on a predetermined configuration setting and/or on factors such as whether subroutine 1000 is allowed and able to read such a vendor-domain cookie.

If in decision block 1005, subroutine 1000 determines that is can read a vendor-domain cookie, then subroutine 1000 proceeds to block 1015. Otherwise, subroutine 1000 proceeds to decision block 1010.

In decision block 1010, subroutine 1000 determines whether it can access an analytics-domain cookie stored on the requesting consumer device. In various embodiments, depending on how marketing-analytics server 200 is configured, such a cookie may be either a first- or third-party cookie.

In various embodiments, subroutine 1000 may determine whether it can access an analytics-domain cookie based in part on a predetermined configuration setting and/or on factors such as whether subroutine 1000 is allowed and able to read such an analytics-domain cookie.

If in decision block 1010, subroutine 1000 determines that is can read an analytics-domain cookie, then subroutine 1000 proceeds to block 1015. Otherwise, subroutine 1000 proceeds to block 1020.

In block 1015, subroutine 1000 reads a consumer-device identifier that was previously associated with the requesting consumer device from an analytics-domain cookie or a vendor-domain cookie. In many embodiments, a consumer-device identifier read from an analytics-domain cookie or vendor-domain cookie may be matched to the requesting consumer device with a high degree of confidence.

Having determined a confident consumer-device identifier, subroutine 1000 ends in ending block 1098, returning the confident consumer-device identifier to the caller.

As discussed above in reference to block 545 of FIG. 5, one or more HTTP header fields (or similar metadata) may be combined with the value of a “User-Agent” HTTP request header to create a request fingerprint that may distinguish requests made by a given remote consumer device from requests made by most other devices.

Using the same process as that employed by subroutine 500, in block 1020, subroutine 1000 determines a request “fingerprint” associated with the given resource request.

As discussed above in reference to FIG. 8, marketing-analytics server 200 may from time to time service requests for “beacon” resource files. As further discussed above in reference to block 715 of FIG. 7, in some embodiments, a message communicated to a consumer via an online-communication address may include identifiers identifying both a tracking resource and a “beacon” resource file, such that when rendering the message, the requesting consumer device may send requests to marketing-analytics server 200 for the tracking resource and the “beacon” resource file.

In decision block 1025, subroutine 1000 determines whether the request “fingerprint” determined in block 1020 matches a request “fingerprint” associated with a recently processed “beacon” resource file request. If so, then subroutine 1000 proceeds to block 1030. Otherwise, subroutine 1000 proceeds to decision block 1035.

In some embodiments, determining whether the request “fingerprint” determined in block 1020 matches a request “fingerprint” associated with a recently processed “beacon” resource file request may be an asynchronous process, as in some cases, a request for a tracking resource may either precede or follow a corresponding request for a “beacon” resource file. In such cases, subroutine 1000 may employ suitable logic to identify “beacon” resource file tracking resource request pairs.

In one embodiment, a predetermined threshold, such as one second or a fraction thereof, may be used in combination with request “fingerprints” to identify “beacon” resource file tracking resource request pairs.

When in decision block 1025, subroutine 1000 determines that the request “fingerprint” determined in block 1020 matches that of a corresponding “beacon” resource file request, subroutine 1000 may be able to determine a consumer-device identifier based on the “beacon” resource file request, as discussed above in reference to block 820 of FIG. 8.

In block 1030, subroutine 1000 identifies a consumer-device identifier associated with the corresponding “beacon” resource file request. In some embodiments, identifying such a consumer-device identifier may include locating a record (e.g., in data store 260) stored as described in block 820 of FIG. 8.

In many embodiments, a consumer-device identifier matched to the requesting consumer device based on a corresponding “beacon” resource file request may have a moderate degree of confidence.

Having determined a moderately confident consumer-device identifier, subroutine 1000 ends in ending block 1098, returning the moderately confident consumer-device identifier to the caller.

In decision block 1035, subroutine 1000 determines whether the request “fingerprint” determined in block 1020 matches that of any other request that was previously received by marketing-analytics server 200 and recorded as discussed above in reference to block 550 of FIG. 5. If so, then subroutine 1000 proceeds to block 1040. Otherwise, subroutine 1000 proceeds to ending block 1099.

In many embodiments, a consumer-device identifier matched to the requesting consumer device based on a corresponding request “fingerprint” may have a relatively low degree of confidence.

Having determined a relatively-low confidence consumer-device identifier, subroutine 1000 ends in ending block 1098, returning the relatively-low confidence consumer-device identifier to the caller.

When subroutine 1000 is unable to identify a matching consumer-device identifier based on the given resource request, subroutine 1000 ends in ending block 1099, returning to the caller.

Although specific embodiments have been illustrated and described herein, it will be appreciated by those of ordinary skill in the art that alternate and/or equivalent implementations may be substituted for the specific embodiments shown and described without departing from the scope of the present disclosure. For example, although the description provided above discusses making in association between a single online-referral source and an offline transaction, in other embodiments, similar systems and methods may be employed to associate two or more online-referral sources with a given offline transaction. This application is intended to cover any adaptations or variations of the embodiments discussed herein.

1. An analytics-server-implemented method for attributing an offline transaction to an online activity, the method comprising:
receiving, by the analytics server, a first request from a remote consumer device for a first hosted resource that is one of a plurality of resources that comprise a vendor page provided by a vendor that enters into offline transactions with consumers;
identifying, by the analytics server, an online-referral source by which said remote consumer device identified said vendor page;
obtaining, by the analytics server, a unique identifier;
recording at least said unique identifier, said online-referral source, and said vendor page in a persistent record;
creating, by the analytics server, a device-identifier association associating said unique identifier with said remote consumer device;
subsequent to receiving said first request, obtaining, by the analytics server, offline-transaction data associating an online-communication address with an offline transaction involving said vendor and an individual or entity;
subsequent to receiving said first request, receiving, by the analytics server, a second resource request from said remote consumer device, said second resource request requesting a second hosted resource;
in response to receiving said second resource request, determining, by the analytics server based at least in part on said device-identifier association, that said remote consumer device is associated with said unique identifier;
determining, by the analytics server based at least in part on metadata associated with said second resource request, that said remote consumer device is associated with said online-communication address and said offline transaction;
associating, by the analytics server, said online-communication address and said offline transaction with said persistent record;
determining, by the analytics server based at least in part on said persistent record and associated online-communication address, that said offline transaction is associated with said online-referral source; and
notifying said vendor that said offline transaction is associated with said online-referral source.

2. The method of claim 1, further comprising:
encoding said online-communication address into a resource identifier identifying said second hosted resource; and
providing said resource identifier for communication to said individual or entity via said online-communication address.

3. The method of claim 2, wherein creating said device-identifier association associating said unique identifier with said remote consumer device comprises:
causing said remote consumer device to persistently record said unique identifier such that said remote consumer device can be subsequently associated with said unique identifier when said remote consumer device makes said second resource request; and
wherein determining that said remote consumer device is associated with said unique identifier comprises retrieving said persistently-recorded unique identifier from said remote consumer device.

4. The method of claim 3, wherein causing said remote consumer device to persistently record said unique identifier comprises requesting that said remote consumer device set a cookie including said unique identifier.

5. The method of claim 3, wherein causing said remote consumer device to persistently record said unique identifier comprises:
encoding said unique identifier into a cache-control identifier associated with a resource file; and
providing said resource file and said cache-control identifier to said remote consumer device such that said remote consumer device will locally cache said resource file and associate it with said cache-control identifier.

6. The method of claim 5, wherein determining that said remote consumer device is associated with said unique identifier comprises:
receiving a third request for said resource file; and
decoding said unique identifier from cache-control metadata associated with said third request.

7. The method of claim 2, wherein creating said device-identifier association associating said unique identifier with said remote consumer device comprises:
determining a first request fingerprint based at least in part on metadata associated with said first request; and
recording said first request fingerprint in said persistent record.

8. The method of claim 7, wherein determining, based at least in part on said device-identifier association, that said remote consumer device is associated with said unique identifier comprises:
determining a second request fingerprint based at least in part on said metadata associated with said second resource request; and
matching said second request fingerprint and said first request fingerprint.

9. The method of claim 1, wherein obtaining said offline-transaction data comprises decoding said offline-transaction data based at least in part on metadata associated with said second resource request.

10. The method of claim 1, wherein said online-referral source comprises an online-search term.

11. A computing apparatus for attributing an offline transaction to an online activity, the apparatus comprising a processor and a memory storing instructions that, when executed by the processor, configure the apparatus to:
receive a first request from a remote consumer device for a first hosted resource that is one of a plurality of resources that comprise a vendor page provided by a vendor that enters into offline transactions with consumers;
identify an online-referral source by which said remote consumer device identified said vendor page;
obtain a unique identifier;
recording at least said unique identifier, said online-referral source, and said vendor page in a persistent record;
create a device-identifier association associating said unique identifier with said remote consumer device;
subsequent to receiving said first request, obtain offline-transaction data associating an online-communication address with an offline transaction involving said vendor and an individual or entity;
subsequent to receiving said first request, receive a second resource request from said remote consumer device, said second resource request requesting a second hosted resource;
in response to receiving said second resource request, determine, based at least in part on said device-identifier association, that said remote consumer device is associated with said unique identifier;
determine, based at least in part on metadata associated with said second resource request, that said remote consumer device is associated with said online-communication address and said offline transaction;
associate said online-communication address and said offline transaction with said persistent record;
determine, based at least in part on said persistent record and associated online-communication address, that said offline transaction is associated with said online-referral source; and
notifying said vendor that said offline transaction is associated with said online-referral source.

12. The apparatus of claim 11, wherein the memory stores further instructions that further configure the apparatus to:
encode said online-communication address into a resource identifier identifying said second hosted resource; and
provide said resource identifier for communication to said individual or entity via said online-communication address.

13. The apparatus of claim 12, wherein the instructions that configure the apparatus to create said device-identifier association associating said unique identifier with said remote consumer device further comprise instructions configuring the apparatus to:
cause said remote consumer device to persistently record said unique identifier such that said remote consumer device can be subsequently associated with said unique identifier when said remote consumer device makes said second resource request; and
wherein determining that said remote consumer device is associated with said unique identifier comprises configuring the apparatus to retrieving said persistently-recorded unique identifier from said remote consumer device.

14. The apparatus of claim 13, wherein the instructions that configure the apparatus to cause said remote consumer device to persistently record said unique identifier further comprise instructions configuring the apparatus to request that said remote consumer device set a cookie including said unique identifier.

15. The apparatus of claim 13, wherein the instructions that configure the apparatus to cause said remote consumer device to persistently record said unique identifier further comprise instructions configuring the apparatus to:
encode said unique identifier into a cache-control identifier associated with a resource file; and
provide said resource file and said cache-control identifier to said remote consumer device such that said remote consumer device will locally cache said resource file and associate it with said cache-control identifier.

16. A non-transient computer-readable storage medium having stored thereon instructions that, when executed by a processor, configure the processor to:
receive a first request from a remote consumer device for a first hosted resource that is one of a plurality of resources that comprise a vendor page provided by a vendor that enters into offline transactions with consumers;
identify an online-referral source by which said remote consumer device identified said vendor page;
obtain a unique identifier;
recording at least said unique identifier, said online-referral source, and said vendor page in a persistent record;
create a device-identifier association associating said unique identifier with said remote consumer device;
subsequent to receiving said first request, obtain offline-transaction data associating an online-communication address with an offline transaction involving said vendor and an individual or entity;
subsequent to receiving said first request, receive a second resource request from said remote consumer device, said second resource request requesting a second hosted resource;
in response to receiving said second resource request, determine, based at least in part on said device-identifier association, that said remote consumer device is associated with said unique identifier;
determine, based at least in part on metadata associated with said second resource request, that said remote consumer device is associated with said online-communication address and said offline transaction;
associate said online-communication address and said offline transaction with said persistent record;
determine, based at least in part on said persistent record and associated online-communication address, that said offline transaction is associated with said online-referral source; and
notifying said vendor that said offline transaction is associated with said online-referral source.

17. The storage medium of claim 16, having stored thereon further instructions that further configure the processor to:
encode said online-communication address into a resource identifier identifying said second hosted resource; and
provide said resource identifier for communication to said individual or entity via said online-communication address.

18. The storage medium of claim 17, wherein the instructions that configure the processor to create said device-identifier association associating said unique identifier with said remote consumer device further comprise instructions configuring the processor to:
cause said remote consumer device to persistently record said unique identifier such that said remote consumer device can be subsequently associated with said unique identifier when said remote consumer device makes said second resource request; and
wherein determining that said remote consumer device is associated with said unique identifier comprises configuring the processor to retrieving said persistently-recorded unique identifier from said remote consumer device.

19. The storage medium of claim 18, wherein the instructions that configure the processor to cause said remote consumer device to persistently record said unique identifier further comprise instructions configuring the processor to request that said remote consumer device set a cookie including said unique identifier.

20. The storage medium of claim 18, wherein the instructions that configure the processor to cause said remote consumer device to persistently record said unique identifier further comprise instructions configuring the processor to:
encode said unique identifier into a cache-control identifier associated with a resource file; and
provide said resource file and said cache-control identifier to said remote consumer device such that said remote consumer device will locally cache said resource file and associate it with said cache-control identifier.
